(19) United States
(12) Patent Application Publication
(10) Pub. No.: US 2021/0347165 A1
(43) Pub. Date: Nov. 11, 2021

(54) ROTATING DRUM PRINTING APPARATUS

(71) Applicant: JIKJI Co., Ltd, Gwangju-si Gyeonggi-do (KR)

(72) Inventors: Jin Hun JUNG, Yongin-si, Gyeonggi-do (KR); Hee Kwan LEE, Yongin-si, Gyeonggi-do (KR); Gil SAGONG, Seoul (KR)

(73) Assignee: JIKJI Co., Ltd, Gwangju-si Gyeonggi-do (KR)

(21) Appl. No.: 17/278,143

(22) PCT Filed: Sep. 6, 2019
(86) PCT No.: PCT/KR2019/011524

§ 371 Date: Mar. 19, 2021

(30) Foreign Application Priority Data
Sep. 19, 2018 (KR) 10-2018-0111908

(51) Int. Cl. B41F 23/04; B41F 27/12; B41F 33/14

(52) U.S. Cl. CPC B41F 23/0453; B41F 33/14; B41F 27/12

(57) ABSTRACT

Disclosed is a drum printing apparatus including: a vacuum drum rotatably supported and coupled to a base and including a drum body shaped like a drum a printing head unit configured to form a set image including a text and a picture in the vacuum drum; a clamping unit configured to perform unclamping for mounting paper from a paper feeder to the drum body and clamping for holding and pressing paper to the drum body; and a cam unit coupled to the base and configured to operate being interlocked with the clamping unit, the clamping unit including a clamping knife coupled to a knife rotating-shaft and configured to be rotatable between a clamping position for pressing paper and an unclamping position for separating from paper, and a pair of clamping brackets coupled to opposite ends of the knife rotating-shaft and configured to be interlocked with the cam unit.

### TECHNICAL FIELD

The disclosure relates to a rotating drum printing apparatus, and more particularly to a rotating drum printing apparatus in which printing paper is more stably clamped to and unclamped from a drum, to which printing paper of various materials is applicable, and which has an improved structure for small quantity batch printing.

### BACKGROUND ART

Humans communicate by various methods in a social life. One of the communication methods is printing, which refers to transferring a text, an image, a picture, etc. onto paper or the surface of other objects in a certain manner and making its many copies.

In other words, the printing is a duplicating technology and action for making printed matter. The original function of the printed matter is a visual delivery medium, and thus the printing is one of communication means and has recently been used as a decorative means for the purpose of sensory ⋅ emotional reaction. To produce the printed matter, a printing technology, i.e., the duplicating technology for making the printed matter is used. The printing technology refers to technology by which many copies of a text, an image, etc. are produced by putting ink on a certain plate surface and transferring the ink to another material (paper is generally used, but cellophane ⋅ polyethylene ⋅ vinyl ⋅ wood ⋅ glass ⋅ ceramics ⋅ aluminum ⋅ a tin plate, etc. are also possible). The purpose of the printing technology is to copy a manuscript as equal as possible by typesetting a sentence with a type or phototypesetting, and making a plate for a drawing or picture with a halftone ⋅ four-color halftone ⋅ multicolored offset plate, etc.

The printing ranges from mimeograph printing to high-speed rotary printing. Further, nowadays, with development of consumption civilization, the printing on not only paper but also a metal plate and cellophane or the like transparent material have been widespread, and the printed pattern has been expanded up to daily necessities such as a print pattern on vinyl or cloth, surface ornamentation on tableware or furniture, etc. As a printing method, screen printing has been on the rise in addition to conventional three methods such as relief printing, offset printing and engraving printing, and electrostatic printing, in which printing is performed without pressing force, has been invented and practically used.

The disclosure is related to a cylindrical drum printing apparatus. In a case of a typical multifunction printer for office use, printing paper is limited to a specific material, and it is very difficult to use a thick and heavy industrial material such as polyvinyl chloride (PVC) or the like. On the other hand, the printing apparatus according to the disclosure can use printing paper of various materials including polyvinyl chloride (PVC).

Meanwhile, in a case of an offset printing apparatus, processes of design→film→print output→platemaking→color mixing→setting→production are required, and a lot of manpower is needed for one piece of equipment. Further, many processes of design→platemaking→color mixing→setting→production are required to produce a printed matter even though a computer-to-plate (CTP) of applying a laser work to a printing plate is used.

### REFERENCE

Japanese Patent Publication No. 2002-120353 (Published on Apr. 23, 2002)

### DISCLOSURE

### Technical Problem

Accordingly, an aspect of the disclosure is to provide a drum printing apparatus in which a range of applicable printing paper is widened to include printing paper of various thicknesses and heavy printing paper.

Further, another aspect of the disclosure is to provide a drum printing apparatus suitable for small quantity batch production.

Further, still another aspect of the disclosure is to provide a drum printing apparatus in which an input image to be printed is controlled corresponding to skewed printing paper even though the printing paper is slantly mounted or clamped to a rotating drum.

Further, yet another aspect of the disclosure is to provide a drum printing apparatus in which feeding, printing, curing, ejecting and loading of printing paper are automatically performed.

### Technical Solution

According to an aspect of the disclosure, there is provided a drum printing apparatus including: a vacuum drum rotatably supported and coupled to a base and including a drum body shaped like a drum to and from which paper for printing is mountable and separatable; a paper feeder loaded with paper and configured to feed the loaded paper to the vacuum drum; a printing head unit configured to form (print) a set image including a text and a picture in the vacuum drum; a clamping unit coupled to the vacuum drum and configured to perform unclamping for mounting paper from the paper feeder to the drum body and clamping for holding and pressing paper to the drum body; a cam unit coupled to the base and configured to operate being interlocked with the clamping unit, the clamping unit including a clamping knife coupled to a knife rotating-shaft and configured to be rotatable between a clamping position for pressing paper and an unclamping position for separating from paper, and a pair of clamping brackets coupled to opposite ends of the knife rotating-shaft and configured to be interlocked with the cam unit, and the cam unit including cams configured to be respectively in contact with cam contact rollers coupled to the pair of clamping brackets so that the knife rotating-shaft can rotate between the clamping position and the unclamping position.

Further, the clamping knife may include an elastically transformable material, and be divided in plural in a rotating axial direction of the drum body and coupled to the knife rotating-shaft at set intervals.

Further, the drum printing apparatus may further include a vision unit configured to detect a distorted degree including a skewed amount and a slanted amount of mounted paper while the drum body is rotating after the paper fed from the paper feeder is mounted to the drum body, wherein an image to be formed by the printing head unit is controlled to be printed by the controller after being corrected as much as the distorted degree detected by the vision unit.

Further, the drum printing apparatus may further include an ink supplying unit configured to supply ink to the printing head unit, wherein the ink supplying unit includes an ink tank configured to accommodate ink, an auxiliary ink reservoir adjacent to the printing head unit and configured to supply the ink pumped from the ink tank to the printing head unit, and a backflow prevention member branched from an ink line connected to the auxiliary ink reservoir and the printing head unit and communicating with an air line connected to the auxiliary ink reservoir and configured to detect whether ink flows back to the air line.

Further, paper from the paper feeder may be fed perpendicularly to the drum body toward a rotating center axis of the drum body.

Further, the paper feeder may include a suction plate rotating member configured to rotate mounted paper so that the paper can be positioned in a gap formed by the clamping knife at the unclamping position.

According to another aspect of the disclosure, there is provided a drum printing apparatus including: a vacuum drum rotatably supported and coupled to a base and including a drum body shaped like a drum to and from which paper for printing is mountable and separatable; a paper feeder loaded with paper and configured to feed the loaded paper to the vacuum drum; a vision unit coupled to the drum body and configured to detect a distorted degree including a skewed amount and a slanted amount of rotating paper; a printing head unit configured to form (print) a set image including a text and a picture in the vacuum drum; an ink supplying unit configured to supply ink to the printing head unit; an ultraviolet (UV) unit configured to cure an image printed in the printing head unit; an ejector configured to eject and load paper printed in the drum body; a clamping unit coupled to the vacuum drum and configured to perform unclamping for mounting paper from the paper feeder to the drum body and clamping for holding and pressing paper to the drum body, and a cam unit coupled to the base and configured to operate being interlocked with the clamping unit.

### Advantageous Effects

As described above, according to the disclosure, there is provided a drum printing apparatus in which a range of applicable printing paper is widened to include printing paper of various thicknesses and heavy printing paper.

Further, there is provided a drum printing apparatus suitable for small quantity batch production

Further, there is provided a drum printing apparatus in which an input image to be printed is controlled corresponding to skewed printing paper even though the printing paper is slantly mounted or clamped to a rotating drum.

Further, there is provided a drum printing apparatus in which feeding, printing, curing, ejecting and loading of printing paper are automatically performed.

### DESCRIPTION OF DRAWINGS

FIG. 1 is a schematic view of a drum printing apparatus according to an embodiment of the disclosure,

FIGS. 2(a) and 2(b) are a plan view and a lateral view of a vacuum drum to describe a clamping unit for clamping and unclamping paper of FIG. 1,

FIGS. 3 and 4 are views for illustrating operations of a cam unit to describe a process that a clamping unit clamps and unclamps paper,

FIGS. 5(a) and 5(b) are conceptual views for describing that a slanted or skewed degree of paper clamped into a drum body is detected by a vision unit and controlled during printing,

FIG. 6 is a conceptual view for describing a printing process based on divided widths of paper,

FIG. 7 is a schematic view for illustrating operations of an ink supplying par, and

FIGS. 8 to 10 are flowcharts for describing operations of a printing apparatus according to the disclosure.

### MODE FOR INVENTION

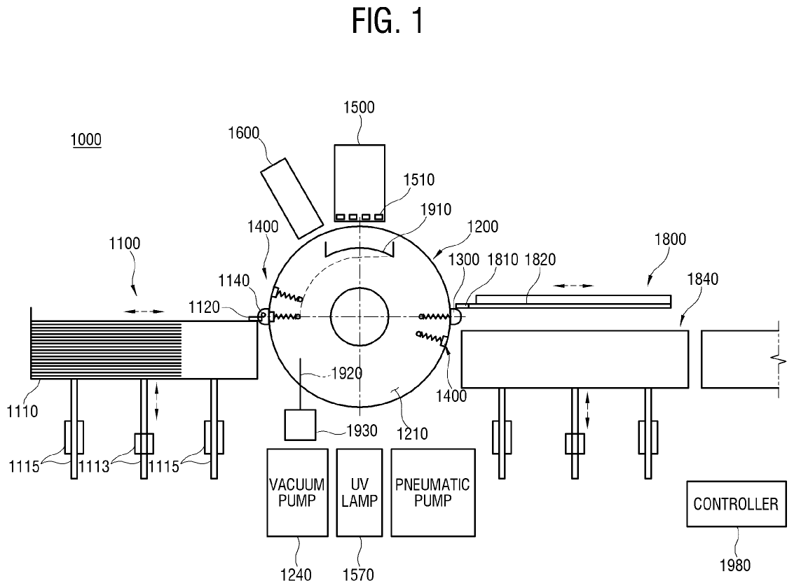

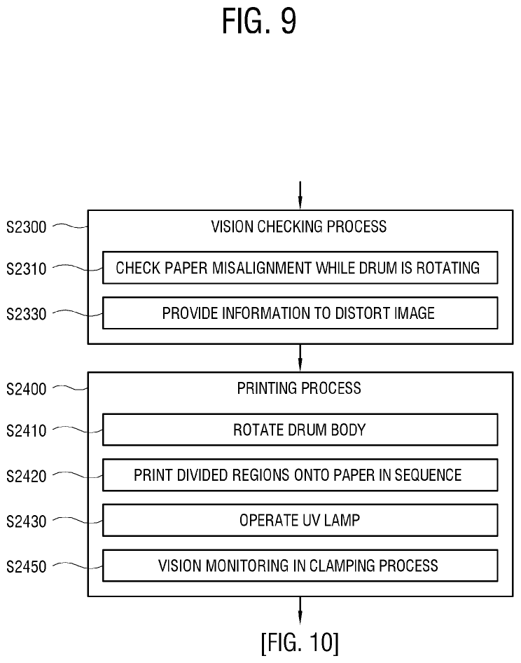

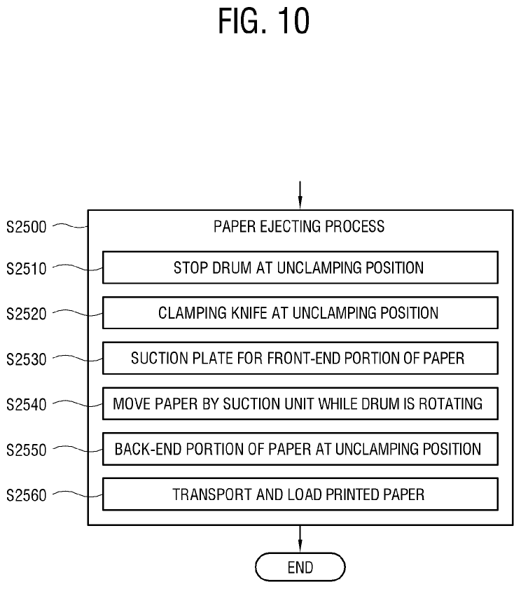

Below, a rotating drum printing apparatus 1000 (hereinafter, referred to as a ‘printing apparatus’) according to an embodiment of the disclosure will be described in detail with reference to FIGS. 1 to 10.

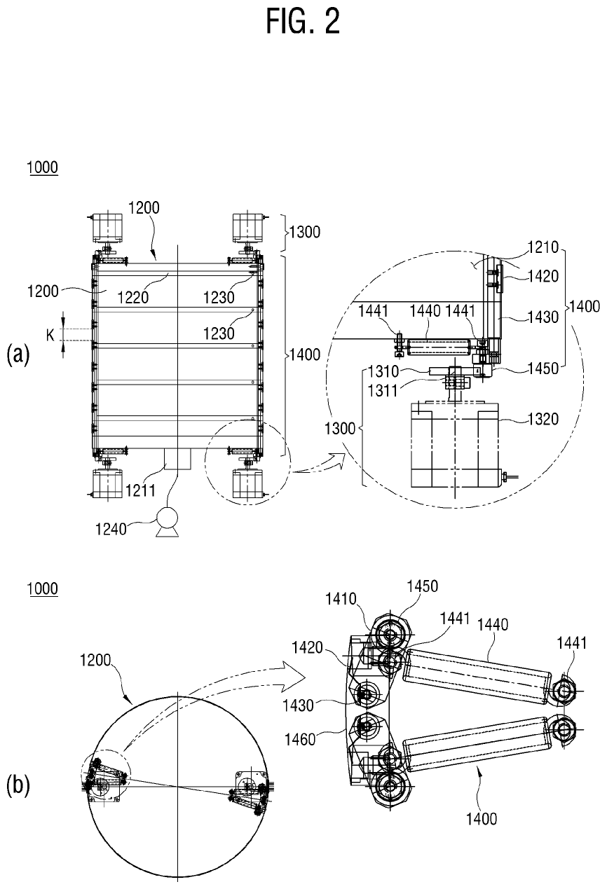

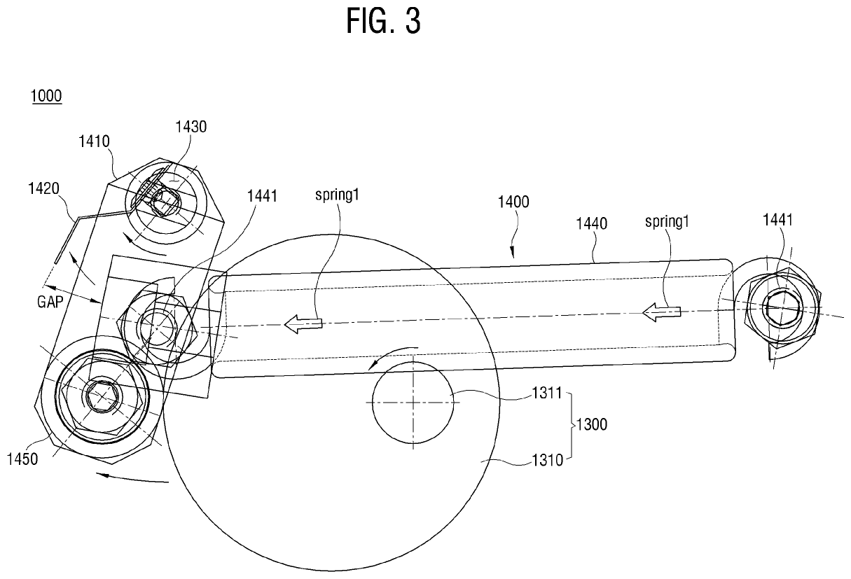

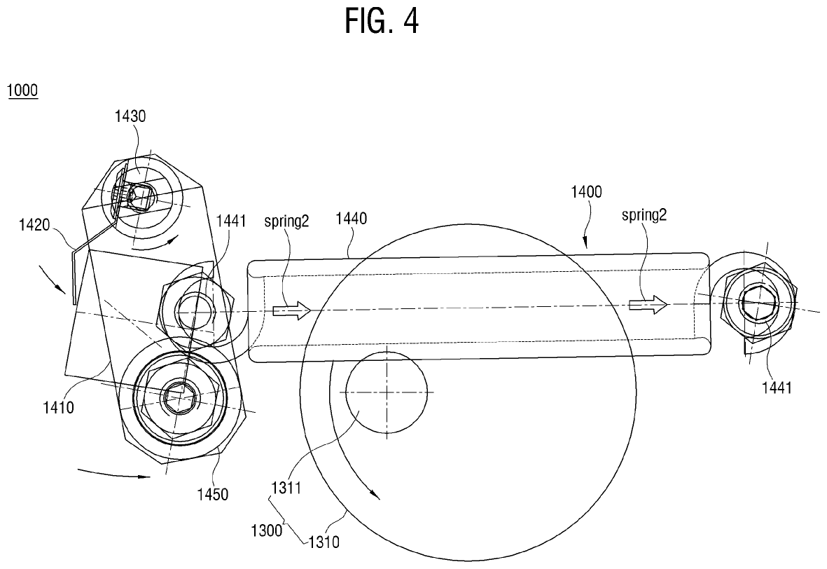

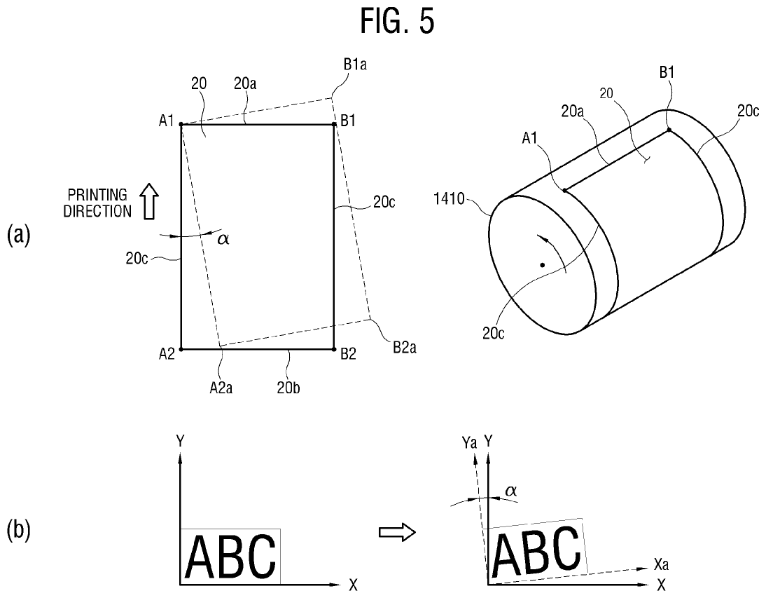

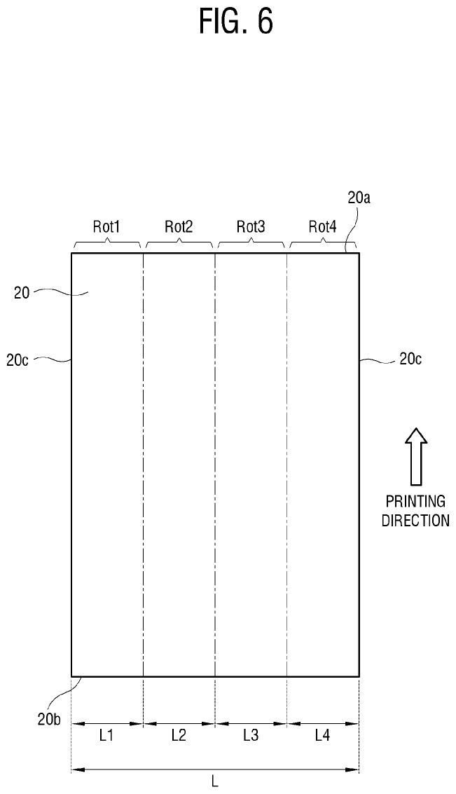

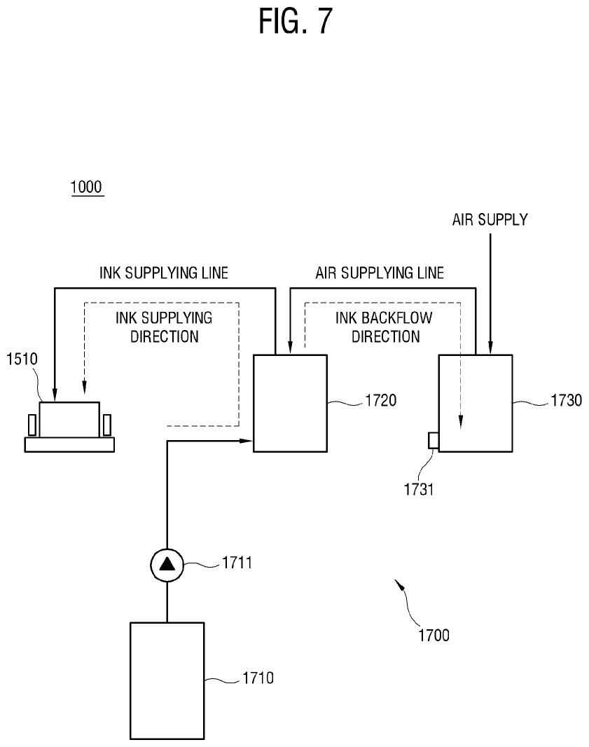

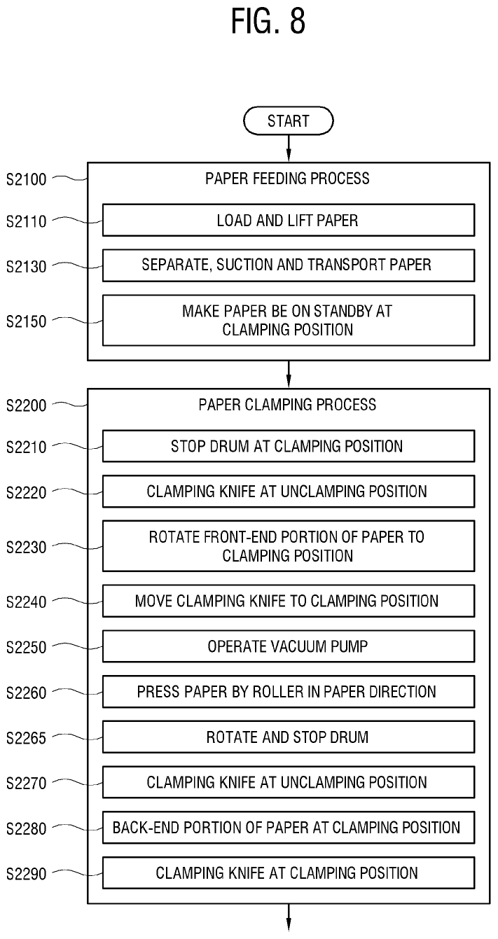

FIG. 1 is a schematic view of a drum printing apparatus according to an embodiment of the disclosure, FIGS. 2a and 2b are a plan view and a lateral view of a vacuum drum to describe a clamping unit for clamping and unclamping paper of FIG. 1, FIGS. 3 and 4 are views for illustrating operations of a cam unit to describe a process that a clamping unit clamps and unclamps paper, FIGS. 5a and 5b are conceptual views for describing that a slanted or skewed degree of paper clamped into a drum body is detected by a vision unit and controlled during printing, FIG. 6 is a conceptual view for describing a printing process based on divided widths of paper, FIG. 7 is a schematic view for illustrating operations of an ink supplying par, and FIGS. 8 to 10 are flowcharts for describing operations of a printing apparatus according to the disclosure.

The printing apparatus 1000 according to an embodiment of the disclosure, as shown in FIGS. 1 to 4 and FIG. 7, includes a paper feeder 1100 configured to feed printing paper 20 on which printing will be performed, a vacuum drum 1200 configured to rotate with the fed paper 20, a clamping unit 1400 and a cam unit 1300 configured to be clamped to and unclamped from the vacuum drum 1200, a vision unit 1600 configured to sense slanting, skewing, etc. of the printing paper 20 mounted to the vacuum drum 1200, a printing head unit 1500 configured to print an input and set image including a text, a picture, etc. on the printing paper 20, an ink supplying unit 1700 configured to supply printing ink to the printing head unit 1500, an ejector 1800 configured to separate and stack the printed paper 20 from the vacuum drum 1200, a cleaning unit 1900 configured to collect the ink from the printing head unit 1500, and a controller 1980 configured to control such components by transmitting and receiving a signal or the like to and from the components and supplying and controlling electromagnetic power to the components. Further, the printing apparatus 1000 may include a frame (not shown) configured to support and accommodate such components.

The paper feeder 1100 includes various components to be loaded with the paper 20 on which printing will be performed, transport the paper 20 sheet by sheet, and feed the paper 20 to a drum body 1210 so that the paper 20 can be mounted to the drum body 1210. The ejector 1800 includes a paper feeding table 1110 shaped like a rectangular parallelepiped and movable up and down with the loaded paper 20 for printing, a paper feeding lift 1113 configured to lift the paper feeding table 1110 up and down by, for example, a ball screw, a plurality of lift guides 1115 provided to stably move the paper feeding table 1110 during operations of the paper feeding lift 1113, and a vacuum suction plate (not shown) configured to feed the paper 20 sheet by sheet, and may further include a paper feeding suction member 1120 having a suction plate rotating member 1123 to stably clamp a front end region of the paper 20 along a circumferential direction of the drum body 1210 by making the paper 20 rotate about 90 degrees at an unclamping position of the clamping unit 1400 so that the paper 20 can be mounted to the drum body 1210, a transport member (not shown) coupling with the paper feeding suction member 1120 to transport the paper from the loaded position up to a position where the clamping unit 1400 is present, a paper separating member configured to take off the paper sheet by sheet by removing the static electricity from the paper or blowing air so that the vacuum suction plate can suction the paper sheet by sheet, and a paper height sensor (not shown) configured to sense the height of the loaded paper.

To more effectively position a front-end portion (see ‘20a’ in FIG. 5(a) perpendicularly to a diameter direction of the drum body 1210 while the paper is mounted from the ejector 1800 to the drum body 1210, an alignment means (not shown) for aligning the paper 20 may be further provided. That is, the paper to be fed and the paper to be ejected are fed or ejected in the diameter direction of the drum body 1210 if possible. As results of inventors' various experiments or tests for comparison with many other cases, it was shown that the paper was most effectively fed and ejected in such a direction.

In other words, the inventors found by various experiments that the most preferable direction of feeding the paper is equal to the diameter direction of the drum body 1210 (i.e. the direction toward the rotating center axis of the drum body) because the feeding paper has to be mounted from the ejector 1800 to the rounded drum body 1210 in the paper feeding process differently from that of a printer used in an ordinary office or the like.

In a case of feeding paper made of polyvinyl chloride (PVC) having a thickness of 0.1˜0.3 mm, various problems, which might occur in the following printing process, were minimized when the paper was fed in the direction perpendicular to the diameter direction of the drum body 1210.

The vacuum drum 1200 may include the drum body 1210 be hollow and rotatable as supported on a drum shaft 1211, a plurality of drum grooves 1220 spaced apart along the rotating direction of the drum body 1210 and recessed on the surface of the drum body 1210, and a vacuum hole 1230 formed at a side of the drum groove 1220, to which a font-end portion 20a of the paper 20 is attached, making the inside of the drum body 1210 communicate with the drum groove 1220, and being interlocked with the clamping unit 1400 and the cam unit 1300 to stably mount the fed paper 20 so that the fed paper can be clamped to and unclamped from the drum body 1210, a vacuum pump 1240 vaccumizing the inside of the drum body 1210 so as to vacuumize even the vacuum hole 1230 and the drum groove 1220, and a clamping unit coupler (not shown) recessed so that the clamping unit 1400 can be coupled onto the surface of the drum body 1210.

The drum body 1210 according to the disclosure is big enough to mount two sheets of A4 paper thereon in a lengthwise direction of the paper, but may have various sizes as necessary.

The vacuum drum 1200 makes the fed paper be in close contact with the surface of the drum body 1210, thereby preventing the mounted paper from being separated or getting loose from the surface of the drum body 1210 by centrifugal force even at fast rotation speed.

In addition, the paper feeder 1100 includes a paper pressing roll member 1140 that presses the paper against the drum body 1210 so that the mounted paper can be in close contact with the drum body 1210 while the drum body 1210 is rotating as the front-end portion of the paper is mounted to the drum body 1210 by the clamping unit 1400 (to be described later), thereby more effectively mounting the paper to the drum body 1210.

To make the rotating vacuum drum 1200 accurately stop and move in setting positions such as a clamping position, an unclamping position, a printing position, etc., the controller 1980 may perform control using an encoder that detects a rotation amount of a drum driver (not shown) including a motor for transmitting power to the drum body 1210.

The cam unit 1300 is coupled to an outer side of the vacuum drum 1200 and interlocked with the clamping unit 1400 to clamp and unclamp the paper to and from the drum body 1210, and includes a cam 1310 having a usual cam structure and rotating with respect to a cam shaft 1311, and a cam driving motor 1320 for transmitting power to the cam shaft 1311, in which the cam driving motor 1320 may for example include a step motor.

The clamping unit 1400, as shown in FIGS. 1 to 4, serves to clamp the paper which is fed as mounted to the drum body 1210, or unclamp the paper of which printing is completed. The clamping unit 1400 is interlocked with the cam unit 1300 at the clamping position where the fed paper will be clamped and the unclamping position where the printing-completed paper will be unclamped, thereby clamping and unclamping the paper to and from a clamping knife 1420.

The clamping unit 1400 includes a knife rotating-shaft 1430 lengthened in a rotating axial direction on the outer circumferential surface of the drum body 1210 and rotatably coupled by a knife rotating-shaft supporting member 1460, a clamping knife 1420 coupled to the knife rotating-shaft 1430 while leaving a predetermined space and clamping the paper to be in close contact with the drum body 1210 while elastically pressing the paper against the drum body 1210, and a clamping bracket 1410.

The clamping bracket 1410 includes a first side each coupled to an end portion of the knife rotating-shaft 1430 and a second side coupled to a cam contact roller 1450 coupled to be in contact with the cam 1310 of the cam unit 1300, and an elastic member holding shaft 1441 is coupled between the knife rotating-shaft 1430 and the cam contact roller 1450 and supporting a clamping elastic member 1440 that elastically presses the clamping knife 1420 to become in contact with the drum body 1210. The clamping elastic member 1440 includes a first side coupled to the elastic member holding shaft 1441 coupled to the clamping bracket 1410, and a second side each coupled to the elastic member holding shaft 1441 coupled to the lateral side of the drum body 1210 and elastically pressing the clamping bracket 1410 toward the drum body 1210 while rotatably supporting the knife rotating-shaft 1430.

Here, the clamping knives 1420 are not continuously lengthened along the knife rotating-shaft 1430 but arranged having a predetermined width at regular intervals (see ‘K’ at the left side of in (a) of FIG. 2. The continuously lengthened clamping knife was not straight but curved and therefore did not effectively press the paper because it is a little thin in a portion to be in contact with the drum body 1210. In other words, if a single clamping knife (not shown) is provided, the clamping knife is relatively thin and thus curved or deformed in a lengthwise direction (or deformed by heat of a process and thin material properties even in the process or the like), thereby rather causing the paper to get loose. Thus, a plurality of clamping knives 1420 having a predetermined width according to the disclosure may be coupled to the knife rotating-shaft 1430. Further, the clamping knife 1420 may include an elastically transformable material. The clamping knife 1420 may be shaped by bending a thin-plate member as shown in the drawings, but may be structured by processing a plate-shaped material.

With this structure, as shown in FIGS. 3 and 4, the clamping knife 1420 of the clamping unit 1400 is interlocked with the cam unit 1300 to perform clamping for mounting, coupling or attaching the paper to the drum body 1210, and unclamping for separating the paper from the drum body 1210. Such operations will be described below in detail with reference to FIGS. 3 and 4.

First, as shown in FIG. 3, the drum body 1210 rotates in position for the paper feeder 1100 to receive the paper or in position for the ejector 1800 to eject the printed paper. Thus, when the cam driving motor 1320 of the cam unit 1300 rotates and the cam 1310 pushes the cam contact roller 1450, the clamping bracket 1410 moves upward with respect to the knife rotating-shaft 1430 (toward the outside of the drum body) and the clamping elastic member 1440 is stretched (see ‘spring 1’ in FIG. 3). Thus, the clamping knife 1420 coupled to the knife rotating-shaft 1430 rotates clockwise with respect to the knife rotating-shaft 1430 and separates from the drum body 1210 to thereby form a gap (see ‘gap’ in FIG. 3). The suction plate rotating member 1123 in the paper feeder 1100 feeds the paper 20 to the gap, and the clamping knife 1420 in the ejector 1800 does not press the paper so that an ejecting suction plate 1810 can suction and separate the printed paper from the drum body 1210. Such operations are simultaneously performed at a time in a pair of clamping brackets 1410 and the cam units 1300 provided at the opposite sides of the clamping unit 1400, so that the knife rotating-shaft 1430 and the clamping knife 1420 can operate without separate distortion.

Next, as shown in FIG. 4, when the cam driving motor 1320 drives the cam 1310 to rotate and the central axis of the cam contact roller 1450 gradually moves to the cam shaft 1311, the clamping bracket 1410 rotates counterclockwise with respect to the knife rotating-shaft 1430 and moves toward the drum body 1210 by the elasticity of the clamping elastic member 1440 (see ‘spring 2’ in FIG. 4), and the clamping knife 1420 is also in contact with the outer circumferential surface of the drum body 1210. When such operations are performed in the paper feeder 1100, the clamping knife 1420 stably and elastically presses the fed paper against the drum body 1210, and the clamping knife 1420 becomes in contact with the outer circumferential surface of the drum body 1210 because the paper suctioned by the ejecting suction plate 1810 in the ejector 1800 is ejected.

By repeating such operations, the clamping knife 1420 clamps and unclamps the font-end portion 20a and the back-end portion 20b of the paper 20, thereby mounting the paper 20 to the drum body 1210 and separating the paper 20 from the drum body 1210.

The vision unit 1600 serves to sense whether the paper 20 for printing is properly mounted or attached to the drum body 1210, by a camera or the like while the paper 20 attached to the drum body 1210 is rotating, and may include a lighting means as necessary. In other words, as shown in (a) of FIG. 5, the paper 20 is required to be normally mounted or aligned in the drum body 1210 as shown in the solid line. However, when the lateral portion 20c of the paper 20 is slanted at a predetermined angle from the normal position as shown in the dotted line of (a) of FIG. 5 for certain reasons (see ‘α’ in FIG. 5(a)), the vision unit 1600 detects and sends the slanted angle to the controller 1980 and then the controller 1980 controls the printing head unit 1500 to print an image, which is obtained by correcting a left normal image into a right slanted image angled (see ‘α’ in FIG. 5(b)) corresponding to the detected angle as shown in FIG. 5(b), on the paper 20. Here, a reference numeral of ‘20a’ is given to the font-end portion of the paper 20, a reference numeral of ‘20b’ is given to the back-end portion, and a reference numeral of ‘20c’ is given to the lateral portion.

Through such operations, an image to be printed is angled as much as the slant of the paper 20 and then printed, thereby making it easier and more convenient to normally print a desired image corresponding to the slanted paper 20 than that by adjusting or controlling the printing head unit 1500.

The printing head unit 1500 serves to print a previously input and set image on the paper 20 mounted to the rotating drum body 1210. The printing head unit 1500 may include a printing head 1510 to which a nozzle (not shown) for discharging ink is coupled, a head mover (not shown) for intermittently moving the printing head 1510 in a rotating axial line, and a head height adjuster (not shown) for adjusting the distance between the printing head 1510 and the drum body 1210, i.e. the height of the printing head 1510.

Further, the printing head unit 1500 performs the printing on the paper, as shown in FIG. 6, by dividing the paper 20 into several areas (see four areas ‘Rot1’ to ‘Rot4’ and ‘L1’ to ‘L4’ in FIG. 6) along the rotating direction, in which the printing head 1510 performs the printing on one region from the left, moves rightward to the next region, and then applies the printing to the other regions in sequence. In other words, the printing is applied to a paper width of ‘L1’ during the first rotation (see ‘Rot1’) of the drum body 1210, a paper width of ‘L2’ during the second rotation (see ‘Rot2’), a paper width of ‘L3’ during the third rotation (see ‘Rot3’), and a paper width of ‘L4’ during the fourth rotation (see ‘Rot4’). In such a printing process, the printing is repeated in an area where the regions are overlapped, in which the controller 1980 may control ink discharging points not to be overlapped.

By such a printing method, it is possible to perform printing of a higher resolution, and make up for a problem caused by a physically clogged nozzle or the like.

An ultraviolet (UV) unit 1570 cures a printed region by, for example, a UI lamp or the like so that an image printed in the printing head unit 1500 can be subjected to curing. The UV unit 1570 may be positioned in a downstream side of the printing head unit 1500 in the rotating direction of the drum body 1210. The UV unit 1570 may, for example, be configured to have a wavelength corresponding to a wavelength range of ink when UV ink is used as the ink, employ a long-life light emitting diode (LED) or the like, and generate less heat.

The ink supplying unit 1700, as shown in FIG. 7, serves to supply the ink to the printing head unit 1500. The ink supplying unit 1700 includes a plurality of ink tanks 1710 respectively accommodating and storing inks according to colors, a plurality of auxiliary ink reservoirs 1720 placed at a relatively high position and storing the inks as much as set amounts corresponding to the respective ink tanks 1710, a backflow prevention member 1730 branched from a line of the ink supplied to the auxiliary ink reservoirs 1720 and the printing head unit 1500 and connected to an air supplying line, and an ink pump 1711 supplying the inks from the ink tanks 1710 to the auxiliary ink reservoirs 1720.

The backflow prevention member 1730 is supplied with air. When the ink flows backward from the auxiliary ink reservoirs 1720 or the printing head unit 1500 to an air line, a backflow sensor 1731 senses the stored ink and informs a user of the backflow. Such a backflow prevention function prevents the ink from being excessively supplied to an ink supplying line, prevents the backflowing ink from being introduced into various pneumatic valves, a regulator and a sensor, and prevents the apparatus from malfunction.

The ejector 1800 includes the ejecting suction plate 1810 suctioning the printed and ejected paper 20 at the unclamping position of the clamping unit 1400, an ejection conveyor 1820 separating and conveying the suctioned paper 20 from the drum body 1210, and a product loading member 1840 being loaded with the conveyed paper 20.

The ejector 1800 functions similarly but operates reversely to the paper feeder 1100 and has typical operations, and therefore details thereof will be omitted in the following description.

However, the position or direction for ejecting the paper 20 may also be oriented in the diameter direction of the drum body 1210 perpendicular to the drum body 1210.

The cleaning unit 1900, as shown in FIG. 1, includes a waste ink tray 1910 collecting residues of ink discharged from the printing head unit 1500 during the printing when the printing head unit 1500 is not positioned for the printing at the lateral side of the drum body 1210 but positioned above and beyond the drum body 1210, a waste ink reservoir 1930 accommodating waste ink, and a waste ink pipe 1920 provided between the waste ink tray 1910 and the waste ink reservoir 1930.

The controller 1980 serves to control the components corresponding to necessary information converted from information based on detection of the foregoing sensor or the like, and control the components to be sequentially and properly driven and operated.

With this configuration, a method of operating the printing apparatus 1000 according to the disclosure will be described below in detail with reference to FIG. 7 and the foregoing drawings.

First, when power is on, the controller 1980 and the components becomes on standby.

Next, when an auto mode button is pressed, a paper feeding process S2100, a paper clamping process S2200, a vision checking process S2300, a printing process S2400, and a paper ejecting process S2500 are performed in sequence.

The paper feeding process S2100 includes a paper loading and lifting process S2110 of loading the paper 20, feeding the loaded paper 20, and lifting a loading table (not shown), a paper separation and suction-transporting process S2130 of separating and suctioning the paper 20 sheet by sheet and transporting the paper 20 toward the drum body 1210 when the clamping unit 1400 is positioned, and a process S2150 of making the suctioned and transported paper 20 be on standby at the clamping position.

In the paper clamping process S2200, when the drum body 1210 is stopped to position the drum body 1210 at the clamping position (S2210), the cam 1310 of the cam unit 1300 operates to make the clamping knife 1420 separate from the outer circumferential surface of the drum body 1210 and form the gap as shown in FIG. 3 at the unclamping position (S2220), the front-end portion of the paper 20 rotates 90 degrees to the clamping position so that the paper 20 being on standby in the paper feeder 1100 can be positioned toward the gap (S2230), the clamping knife 1420 is moved to the clamping position so that the cam 1310 of the cam unit 1300 can rotate and the clamping knife 1420 can press the outer circumferential surface of the drum body 1210 in order to clamp and mount the paper 20 to the drum body 1210 (S2240), the vacuum pump 1240 operates so that the drum groove 1220 of the drum body 1210 can be vacuumized to make the paper 20 be in close contact with the drum body 1210 (S2250), and at the same time the paper pressing roll member 1140 of the paper feeder 1100 presses the paper 20 against the surface of the drum body 1210 so that the paper 20 can be in close contact with the drum body 1210 during the rotation (S2260). The vacuum pump 1240 operates in the state that the font-end portion 20a of the paper 20 is clamped onto the surface of the drum body 1210 by the clamping knife 1420, and the drum body 1210 rotates pressing the paper 20 with the paper pressing roll member 1140 and stops so that the clamping unit 1400 and the cam unit 1300 can operate at the back-end portion 20b of the paper 20 (S2265). In this state, when the cam 1310 of the cam unit 1300 operates to make the clamping knife 1420 form the gap from the surface of the drum body 1210 (S2270), the back-end portion 20b of the paper 20 is positioned in this gap (S2280). Then, the cam 1310 rotates further to make the clamping knife 1420 move to the clamping position for firmly pressing the back-end portion 20b of the paper 20 (S2290). Through such processes, one sheet of paper 20 is mounted throughout half of the circumferential surface of the drum body 1210 and subjected to the same paper clamping process S2200, and the other sheet of paper 20 is mounted to the other half of the circumferential surface of the drum body 1210.

In the vision checking process S2300, which refers to a process for detecting how the paper 20 mounted to the drum body 1210 is skewed or slanted from the normal position as shown in FIG. 5(a), the points (for example, see ‘A1’ ‘A2’ ‘B1’ and ‘B2’ in FIG. 5(a)) of the paper 20 are identified by the camera while the drum body 1210 is rotating and a skewed degree as shown in a dotted line (see ‘α’, and ‘A1’ ‘A2a’ ‘B1a’ and ‘B2a’ in FIG. 5(a)) from such normal position is checked (S2310), and the checked information is transmitted to the controller 1980 (S2330). Based on the information transmitted to the controller 1980, an image is slantly printed on the paper 20 by the printing head unit 1500 according to the skewed degree as described above and shown in FIG. 5(b).

In the printing process S2400, the drum body 1210 is rotating (S2410) and the printing head unit 1500 performs printing by spraying necessary ink onto the set and divided regions of the paper 20 based on sequentially input pieces of information (S2420) as shown in FIG. 6. As the printed paper 20 rotates, the printed ink passes by the UV unit 1570 and cured by light or heat (S2430). Even the printing process S2400 includes a process of identifying the skewed degree of the paper 20 in real time and performing the printing with an image controlled based on the identified information (S2450).

In the paper ejecting process S2500 for discharging the printed and cured paper from the drum body 1210, when the drum body 1210 stops at the unclamping position in reverse order of the foregoing paper feeding process and clamping process (S2510), and the cam 1310 operates to make the clamping knife 1420 reach the unclamping position to unclamp the paper 20 (S2520), the ejecting suction plate 1810 suctions and moves the font-end portion 20a of the paper (S2530) and the drum body 1210 rotates corresponding to the moving speed and stops so that the back-end portion 20b of the paper 20 can be positioned at the unclamping position and the paper 20 can be unclamped (S2550), thereby transporting the paper 20 and loading the transported paper 20 (S2560). Such a process is applied again to the other sheet of paper 20, and thus two sheets of paper 20 mounted to the drum body 1210 are ejected and loaded.

Thus, according to the disclosure, there is provided a drum printing apparatus in which a range of applicable printing paper is widened to include printing paper of various thicknesses and heavy printing paper.

Further, there is provided a drum printing apparatus suitable for small quantity batch production.

Further, there is provided a drum printing apparatus in which an input image to be printed is controlled corresponding to skewed printing paper even though the printing paper is slantly mounted or clamped to a rotating drum.

Further, there is provided a drum printing apparatus in which feeding, printing, curing, ejecting and loading of printing paper are automatically performed.

Although embodiments of the disclosure have been shown and described, it will be appreciated by a person having ordinary skill in the art, to which the disclosure pertains, that various changes can be made in these embodiments without departing from the principles and spirit of the disclosure, the scope of which is defined in the appended claims and their equivalents.

[Reference Numerals]

| | |
|---|---|
| 1000: printing apparatus | 20: (printing) paper |
| 1100: paper feeder | 1110: paper feeding table |
| 1113: paper feeding lift | 1115: lift guide |
| 1120: paper feeding suction member | |
| 1123: suction plate rotating member | |
| 1140: paper pressing roll member | |
| 1200: vacuum drum | 1210: drum body |
| 1211: drum shaft | 1220: drum groove |
| 1230: vacuum hole | 1240: vacuum pump |
| 1250: clamping unit coupler | |
| 1300: cam unit | 1310: cam |
| 1311: cam shaft | 1320: cam driving motor |
| 1400: clamping unit | 1410: clamping bracket |
| 1420: clamping knife | |
| 1430: knife rotating-shaft | |
| 1440: clamping elastic member | |
| 1441: elastic member holding shaft | |
| 1450: cam contact roller | |
| 1460: knife rotating-shaft supporting | |
| member | |
| 1500: printing head unit | 1510: printing head |
| 1570: UV unit | 1600: vision unit |
| 1700: ink supplying unit | 1710: ink tank |
| 1711: ink pump | |
| 1720: auxiliary ink reservoir | |
| 1730: backflow prevention member | |
| 1731: backflow sensor | |
| 1800: ejector | |
| 1810: ejecting suction plate | |
| 1820: ejection conveyor | |
| 1840: product loading member | |
| 1900: cleaning unit | 1910: waste ink tray |
| 1920: waste ink pipe | 1930: waste ink reservoir |
| 1980: controller | |

### INDUSTRIAL APPLICABILITY

According to the disclosure, there is provided a drum printing apparatus in which a range of applicable printing paper is widened to include printing paper of various thicknesses and heavy printing paper.

Further, there is provided a drum printing apparatus suitable for small quantity batch production.

Further, there is provided a drum printing apparatus in which an input image to be printed is controlled corresponding to skewed printing paper even though the printing paper is slantly mounted or clamped to a rotating drum.

Further, there is provided a drum printing apparatus in which feeding, printing, curing, ejecting and loading of printing paper are automatically performed.

1. A drum printing apparatus comprising:
a vacuum drum rotatably supported and coupled to a base and comprising a drum body shaped like a drum to and from which paper for printing is mountable and separatable;
a paper feeder loaded with paper and configured to feed the loaded paper to the vacuum drum;
a printing head unit configured to form (print) a set image comprising a text and a picture in the vacuum drum;
a clamping unit coupled to the vacuum drum and configured to perform unclamping for mounting paper from the paper feeder to the drum body and clamping for holding and pressing paper to the drum body;
a cam unit coupled to the base and configured to operate being interlocked with the clamping unit,
the clamping unit comprising a clamping knife coupled to a knife rotating-shaft and configured to be rotatable between a clamping position for pressing paper and an unclamping position for separating from paper, and a pair of clamping brackets coupled to opposite ends of the knife rotating-shaft and configured to be interlocked with the cam unit, and
the cam unit comprising cams configured to be respectively in contact with cam contact rollers coupled to the pair of clamping brackets so that the knife rotating-shaft can rotate between the clamping position and the unclamping position.

2. The drum printing apparatus according to claim 1, wherein the clamping knife comprises an elastically transformable material, and is divided in plural in a rotating axial direction of the drum body and coupled to the knife rotating-shaft at set intervals.

3. The drum printing apparatus according to claim 1, further comprising a vision unit configured to detect a distorted degree comprising a skewed amount and a slanted amount of mounted paper while the drum body is rotating after the paper fed from the paper feeder is mounted to the drum body,
wherein an image to be formed by the printing head unit is controlled to be printed by the controller after being corrected as much as the distorted degree detected by the vision unit.

4. The drum printing apparatus according to claim 1, further comprising an ink supplying unit configured to supply ink to the printing head unit,
wherein the ink supplying unit comprises an ink tank configured to accommodate ink, an auxiliary ink reservoir adjacent to the printing head unit and configured to supply the ink pumped from the ink tank to the printing head unit, and a backflow prevention member branched from an ink line connected to the auxiliary ink reservoir and the printing head unit and communicating with an air line connected to the auxiliary ink reservoir and configured to detect whether ink flows back to the air line.

5. The drum printing apparatus according to claim 1, wherein paper from the paper feeder is fed perpendicularly to the drum body toward a rotating center axis of the drum body.

6. The drum printing apparatus according to claim 2, wherein the paper feeder comprises a suction plate rotating member configured to rotate mounted paper so that the paper can be positioned in a gap formed by the clamping knife at the unclamping position.

7. A drum printing apparatus comprising:
a vacuum drum rotatably supported and coupled to a base and comprising a drum body shaped like a drum to and from which paper for printing is mountable and separatable;
a paper feeder loaded with paper and configured to feed the loaded paper to the vacuum drum;
a vision unit coupled to the drum body and configured to detect a distorted degree comprising a skewed amount and a slanted amount of rotating paper;
a printing head unit configured to form (print) a set image comprising a text and a picture in the vacuum drum;
an ink supplying unit configured to supply ink to the printing head unit;
an ultraviolet (UV) unit configured to cure an image printed in the printing head unit;
an ejector configured to eject and load paper printed in the drum body;
a clamping unit coupled to the vacuum drum and configured to perform unclamping for mounting paper from the paper feeder to the drum body and clamping for holding and pressing paper to the drum body, and
a cam unit coupled to the base and configured to operate being interlocked with the clamping unit.

8. The drum printing apparatus according to claim 2, further comprising a vision unit configured to detect a distorted degree comprising a skewed amount and a slanted amount of mounted paper while the drum body is rotating after the paper fed from the paper feeder is mounted to the drum body,
wherein an image to be formed by the printing head unit is controlled to be printed by the controller after being corrected as much as the distorted degree detected by the vision unit.
